(19) United States
(12) Patent Application Publication
(10) Pub. No.: US 2008/0083762 A1
(43) Pub. Date: Apr. 10, 2008

(54) Oil cistern structure

(76) Inventor: Hsin-Chi Su, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,768

(22) Filed: Oct. 4, 2007

(30) Foreign Application Priority Data
Oct. 5, 2006 (TW) 095137181

(51) Int. Cl. B60P 3/00

(52) U.S. Cl. 220/564

(57) ABSTRACT

An oil cistern structure is applied to a water conveyance. The water conveyance has a plurality of cargo holds troughs, a bridge and two lateral oil cisterns disposed under the bridge, and the oil cistern structure comprising:

a oil cistern, disposed between the cargo holds troughs and the two lateral oil cisterns, and the oil cistern being connected with the two lateral oil cisterns to make the oil carried by the water conveyance be communicated between the oil cistern and the two lateral oil cisterns. The oil cistern structure of the present invention allows the oil to be connected and communicated each other to exempt from disposing connection pipes between the two side fuel tanks and the oil stock of the water conveyance are also increased.

### BACKGROUND OF THE INVENTION

1. Field of the Invention

The invention relates to an oil cistern. More particularly, the invention relates to an oil cistern structure applicable for water conveyance and the related installation of the oil tank for increasing the capacity of oil storage of the water conveyance.

2. Description of Related Art

In the recent decade, the design of oil cisterner is to provide the double hull in the region of oil cargo hold. In this design, an oiltight compartment is provided between a hull and an oiltight bulkhead which actually functions as an inner hull. This oiltight compartment is designed for an empty space or a space fulled of ballast water. Furthermore, a fuel oil storage tank is often right next to an engine room and at a high position in ship, making the space become crowded. If the construct is double hull, either the available space will decrease or the overall size of ship will increase, bringing about serious design problems, cost boost or the both.

FIG. 1 is a drawing, schematically illustrating a conventional ship structure. Referring to FIG. 1, a ship 10 possess a plurality of cargo hold troughs 13 and two lateral oil cisterns 11, wherein the cargo hold troughs 13 and the two lateral oil cisterns 11 are separated by a partition 14 and the two lateral oil cisterns 11 are communicated by a leveling pipe 12 that makes the comsumptions of two lateral oil cisterns 11 be equivalent.

However, the fuel oil storaged in such oil cisterns is exhausted when the voyage is finished and then needs to replenish the stock. If the price of crude oil is rapidly raised, it follow that the cost of navigation will raise and the operation cost will increase.

### SUMMARY OF THE INVENTION

Accordingly, the present invention is directed to an oil cistern structure for satisfying the operating cost down and providing the arrangement of oil cistern in double hulled ship and the new design of increasing oil storage.

The present invention provides an oil cistern structure, which is applicable for a water conveyance, the water conveyance having a plurality of cargo hold troughs, a bridge and two lateral oil cisterns disposed under the bridge, and the oil cistern structure comprising: an oil cistern disposed between the cargo hold troughs and the two lateral oil cisterns, and the oil cistern being connected with the two lateral oil cisterns to let the oil carried by the water conveyance be communicated between the oil cistern and the two lateral oil cisterns. The oil cistern structure not only economizes the leveling pipe set between the two lateral oil cisterns but also increases the oil storage of the water conveyance.

Besides, the oil cistern structure of the present invention, the oil cistern is an rectangle oil tank, is in parallel with the side-by-side cargo hold troughs and connected and communicated with the two lateral oil cisterns, and the oil cistern combined with the two lateral oil cisterns is aerially viewed as a [symbol] -shape. The lengths of three sides of the [symbol] -shape are equivalent or non-equivalent, or the lengths of at least two sides of the [symbol] -shape are equivalent. The oil cistern can also comprise, in a double hull, an oil tank which is set in a ballast tank space under the cargo hold troughs, to carry the fuel oil and also increase the capacity of oil storage of the water conveyance.

In conclusion, the capacity of oil storage, in the present invention, is substantially increased by the oil cistern structure and the installation of the oil tank at the bottom of hold. The complicated pipeline apparatus and the danger of damaged pipeline can be prevented by the oil cistern structure of the present invention. Besides, the oil cistern and oil tank of the present invention are applied to regulate the cost of fuel oil, replenish the stock in advance when price down and use the stock when price up. Regulating the cost of fuel oil by huge stocks for making the more profit. The present invention can also applied in the fuel bunker of any ship such as a passenger ship, a liner and a freighter etc.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing, schematically illustrating a conventional ship structure.

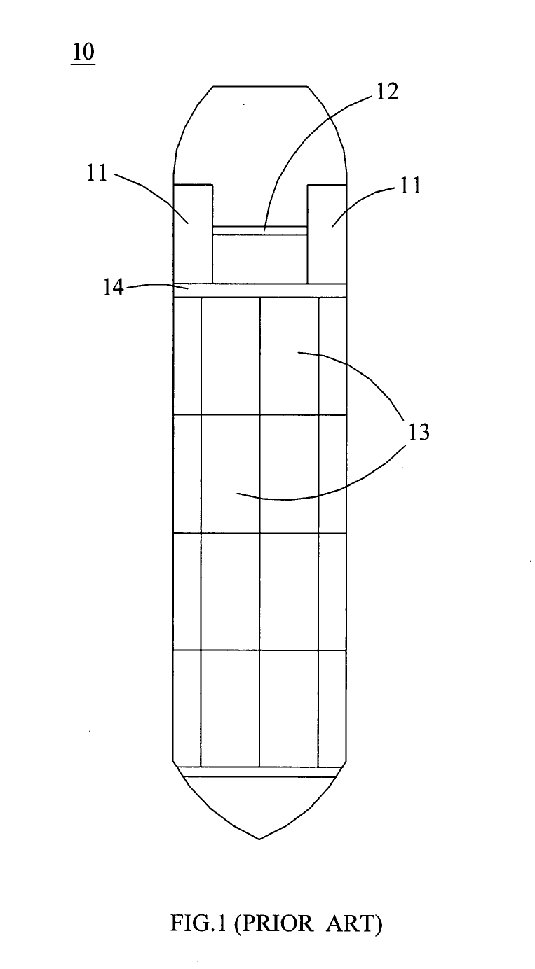

FIG. 2 is a drawing of top view, schematically illustrating an oil cistern structure according to one embodiment of the present invention.

FIG. 3 is a drawing of lateral view, schematically illustrating an oil cistern structure according to one embodiment of the present invention.

FIG. 4 is a drawing of top view, schematically illustrating an oil cistern structure according to another embodiment of the present invention.

FIG. 5 is a drawing of lateral view, schematically illustrating an oil cistern structure according to another embodiment of the present invention.

FIG. 6 is a drawing of top view, schematically illustrating an oil cistern structure according to other embodiment of the present invention.

FIG. 7 is a drawing of lateral view, schematically illustrating an oil cistern structure according to other embodiment of the present invention.

FIG. 8 is a schematic drawing, illustrating a compressible tank of oil cistern structure according to one embodiment of the present invention.

### DETAILED DESCRIPTION OF THE PREFERRED EMBODIMENTS

Reference will now be made in detail to the preferred embodiments of the invention, examples of which are illustrated in the accompanying drawings. Wherever possible, the same reference numbers are used in the drawings and the description to refer to the same or like parts.

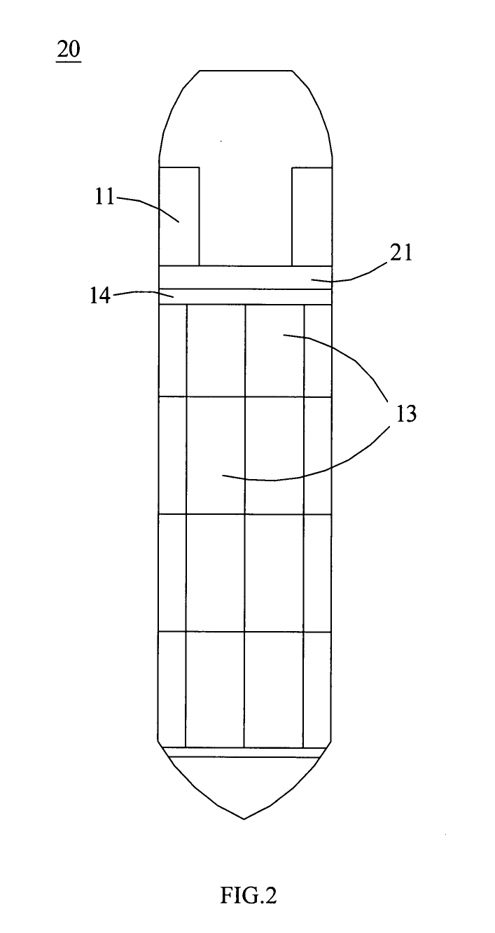

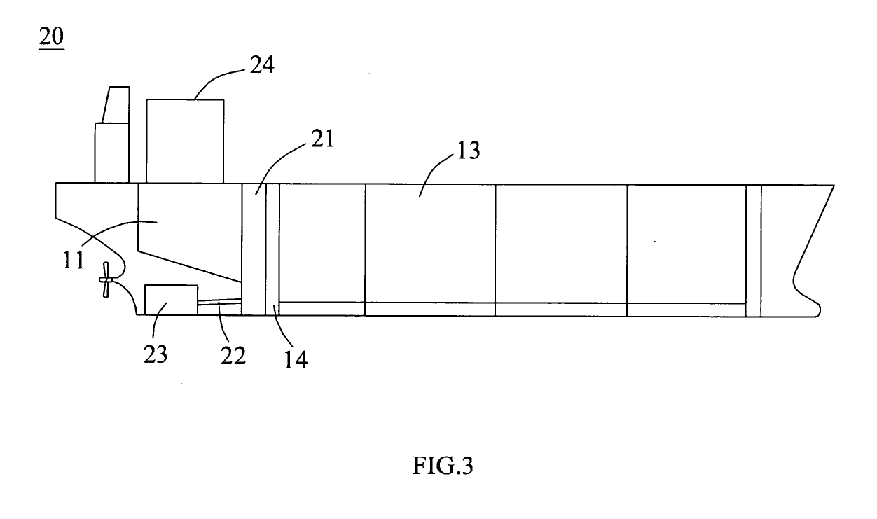

FIG. 2 is a drawing of top view, schematically illustrating an oil cistern structure according to one embodiment of the present invention. FIG. 3 is a drawing of lateral view, schematically illustrating an oil cistern structure according to one embodiment of the present invention. Referring to FIG. 2 and FIG. 3, an oil cistern structure is applicable for a water conveyance 20 having a plurality of cargo hold troughs 13, a bridge 24 and two lateral oil cisterns 11 disposed under the bridge 24. The oil cistern structure comprises an oil cistern 21 disposed between the cargo hold troughs 13 and the two lateral oil cisterns 11. The oil cistern 21 is in parallel with the side-by-side cargo hold troughs and connected with the two lateral oil cisterns to make the oil carried by the water conveyance be communicated with each other. The oil cistern structure further comprises an oil line 22 to supply the fuel oil of oil cistern 21 and two lateral oil cisterns 11 to fuel apparatus 23. This kind of oil cistern structure can increase the capacity of oil storage of the water conveyance 20.

As the above, the oil cistern is a rectangle oil tank, and the oil tank is in parallel with the side-by-side cargo hold troughs and connected and communicated with the two lateral oil cisterns, and the oil cistern combined with the two lateral oil cisterns is aerially viewed as a [symbol] -shape. (Referring to FIG. 2) The lengths of three sides of the [symbol] -shape are equivalent or non-equivalent, or the lengths of at least two sides of the [symbol] -shape are equivalent. The water conveyance generally is a cargo ship, an oil tanker or a ship etc. The oil cistern comprises a division space between the cargo hold troughs and the two lateral oil cisterns. Bulkheads between the division space and the cargo hold troughs comprise a crushproof material or an elastic material etc. And, the oil cistern probably comprises a capacity that is formed by reducing the cargo hold troughs adjoined to the two lateral oil cisterns, and the capacity is a division space of the oil cistern. The division space comprises a crushproof structure or an elastic structure. The oil cistern structure further comprises at least one oil tank. The oil tank is disposed in a ballast tank of double hull of bottom under the cargo hold troughs. The double hull can be used as an oil tank and an extractor is set between the oil tanks to transport the oil within. The extractor is a pump, an oil hydraulic pump, a screw pump or a siphon device. The oil tank also comprises a compressible tank and the compressible tank is compressed by the pressure of ballast water in the water conveyance.

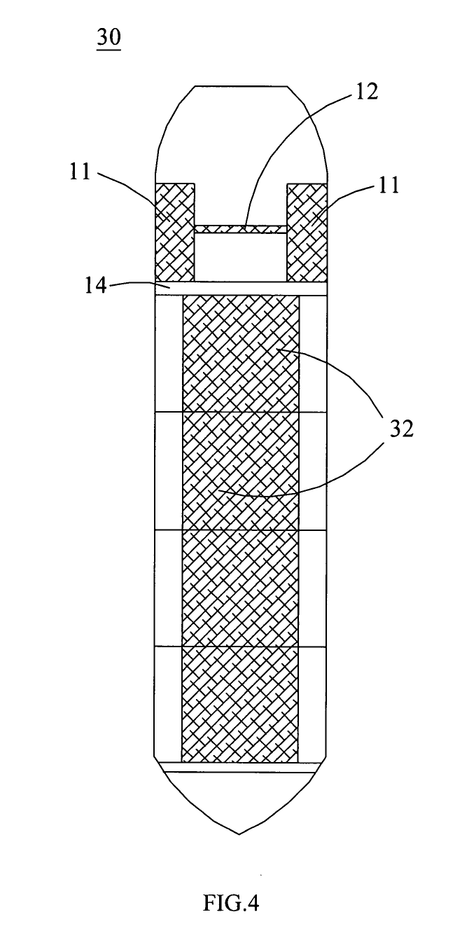

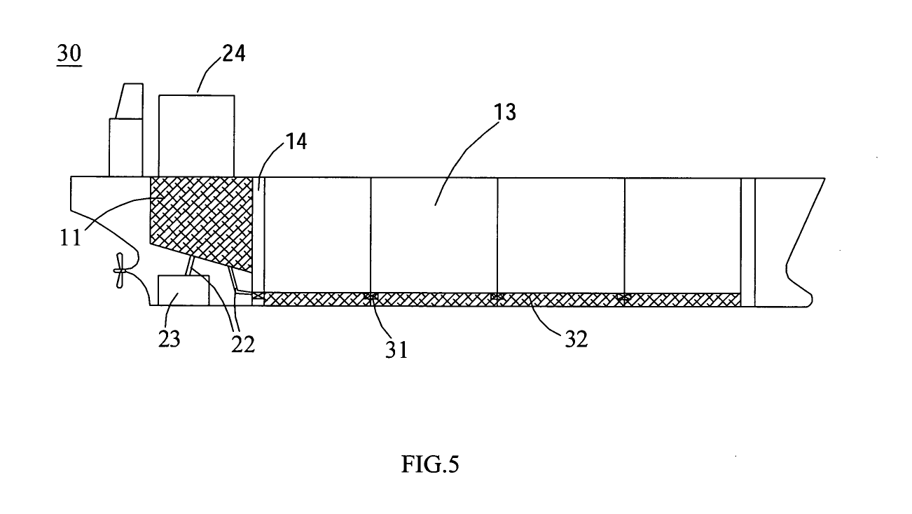

FIG. 4 is a drawing of top view, schematically illustrating an oil cistern structure according to another embodiment of the present invention. FIG. 5 is a drawing of lateral view, schematically illustrating an oil cistern structure according to another embodiment of the present invention. Referring to FIG. 4 and FIG. 5, an oil cistern structure applicable for a water conveyance 30 has at least one oil tank 32, at least one extractor 31, two lateral oil cisterns 11 and at least one oil line 22. The oil tank 32 carries the fuel oil and is disposed in a double hull of bottom under the cargo hold troughs 13 of the water conveyance 30. The double hull can be used as the oil tank 32. The extractor 31 is set between the oil tank 32 to transport the fuel oil within. The two lateral oil cisterns 11, disposed under the bridge 24 of the water conveyance 30, carry the fuel oil and supply it to the fuel apparatus 23. The oil line 22 supplies the fuel oil of oil tank 32 to the two lateral oil cisterns 11 or supply the fuel oil from the two lateral oil cisterns 11 to the fuel apparatus 23. This extension oil tank 32 under the cargo hold troughs 13 can carry the fuel oil and increase the capacity of oil storage of the water conveyance 30.

As the above, the water conveyance generally is a cargo ship, an oil tanker or a ship etc. The extractor generally is a pump, an oil hydraulic pump, a screw pump or a siphon device. The oil tank also comprises a compressible tank and the compressible tank is compressed by the pressure of ballast water in the water conveyance.

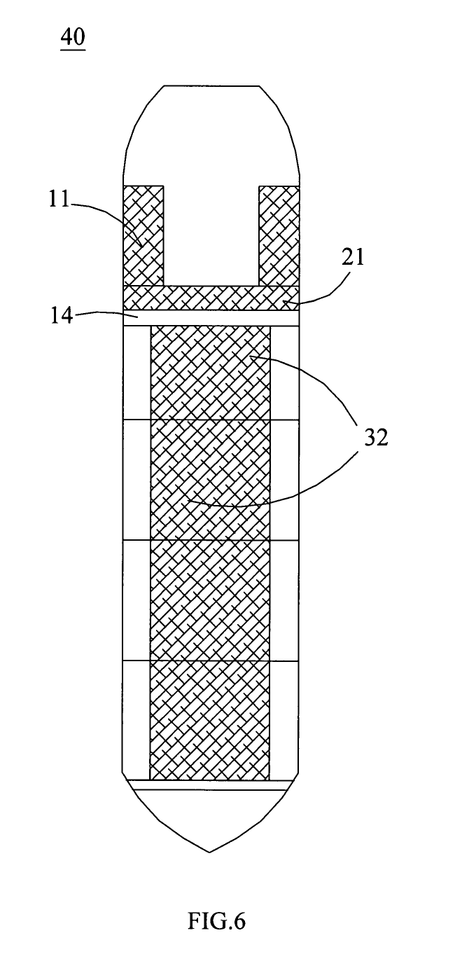

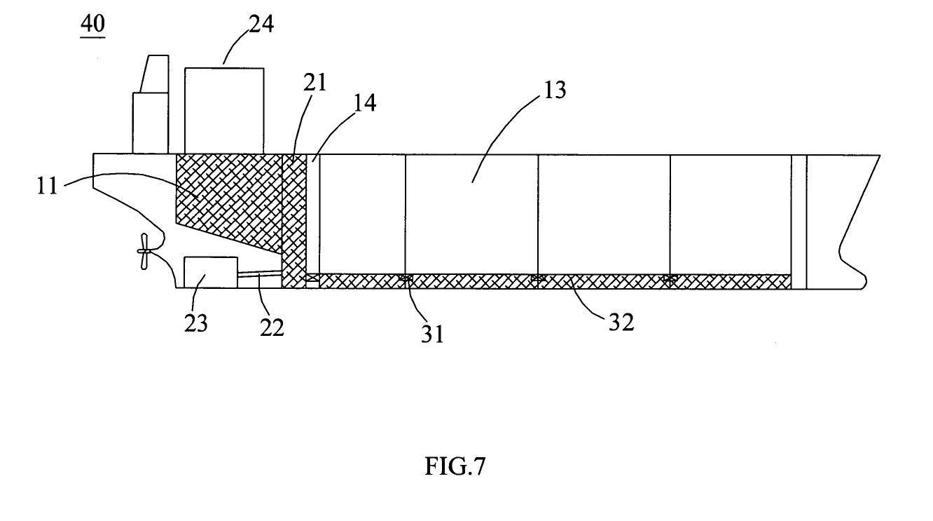

FIG. 6 is a drawing of top view, schematically illustrating an oil cistern structure according to other embodiment of the present invention. FIG. 7 is a drawing of lateral view, schematically illustrating an oil cistern structure according to other embodiment of the present invention. Referring to FIG. 6 and FIG. 7, an oil cistern structure applicable for a water conveyance 40 has at least one oil tank 32, at least one extractor 31, two lateral oil cisterns 11, an oil cistern 21 and at least one oil line 22. The oil tank 32 carries the fuel oil and is disposed in a double hull of bottom under the cargo hold troughs 13 of the water conveyance 40. The double hull can be used as the oil tank 32. The extractor 31 is set between the oil tank 32 and between the oil tank 32 and the oil cistern 21 to transport the fuel oil within. Both of the two lateral oil cisterns 11 and the oil cistern 21 carry the fuel oil and are disposed under the bridge 24 of the water conveyance 40. The oil cistern 21 can be set at a capacity that is formed by reducing the cargo hold troughs adjoined to the two lateral oil cisterns, and the capacity is a division space 41 of the oil cistern 21. The division space comprises a crushproof structure or an elastic structure and supply the fuel oil to the fuel apparatus 23. The oil cistern 21 is in parallel with the side-by-side cargo hold troughs and connected and communicated with the two lateral oil cisterns under the bridge 24. The oil cistern 21 is communicated with the oil tank 32. The oil line 22 supplies the fuel oil of the oil cistern 21 and two lateral oil cisterns 11 to the fuel apparatus 23. This extension oil tank 32 under the cargo hold troughs 13 can carry the fuel oil and increase the capacity of oil storage of the water conveyance 40.

As the above, the oil cistern is a rectangle oil tank, and the oil tank is in parallel with the side-by-side cargo hold troughs and connected and communicated with the two lateral oil cisterns, and the oil cistern combined with the two lateral oil cisterns is aerially viewed as a [symbol] -shape. (Referring to FIG. 6) The lengths of three sides of the [symbol] -shape are equivalent or non-equivalent, or the lengths of at least two sides of the [symbol] -shape are equivalent. The water conveyance generally is a cargo ship, an oil tanker, a dry cargo ship or a ship etc. The extractor is a pump, an oil hydraulic pump, a screw pump or a siphon device. The oil tank also comprises a compressible tank and the compressible tank is compressed by the pressure of ballast water in the water conveyance.

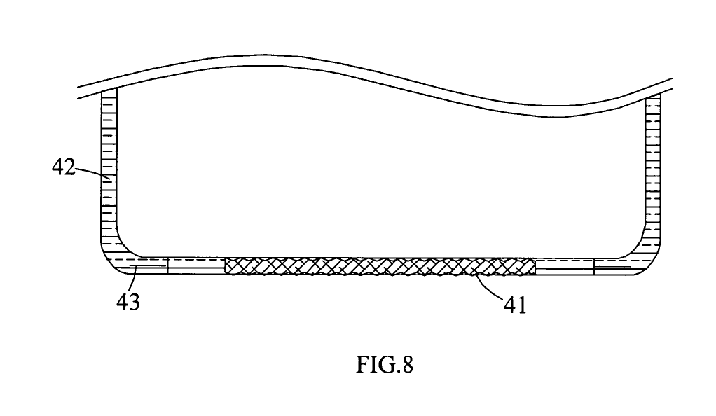

FIG. 8 is a schematic drawing, illustrating a compressible tank of oil cistern structure according to one embodiment of the present invention. Referring to FIG. 8, a compressible tank 41 is compressed by the pressure 43 of ballast water 42 in the water conveyance and the fuel oil in the compressible tank 41 is compressed and then transported to the oil cistern 21 under the bridge 24.

In summary, the capacity of oil storage of the water conveyance, in the present invention, is substantially increased by the oil cistern structure and the installation of the oil tank at the bottom of hold. The complicated pipeline apparatus and the danger of damaged pipeline can be prevented by the [symbol] -shape oil cistern structure of the present invention.

Furthermore, the [symbol] -shape oil cistern and tank of the present invention can be applied to regulate the cost of fuel oil, replenish the stock in advance when price down and use the stock when price up. Regulating the cost of fuel oil by the huge stocks for making the more profit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An oil cistern structure, applicable for a water conveyance having a plurality of cargo hold troughs, a bridge and two lateral oil cisterns disposed under the bridge, and the oil cistern structure comprising:
an oil cistern, disposed between the cargo hold troughs and the two lateral oil cisterns, and the oil cistern being connected with the two lateral oil cisterns to make the oil carried by the water conveyance be communicated between the oil cistern and the two lateral oil cisterns.

2. The oil cistern structure according to claim 1, wherein the oil cistern is a rectangle oil tank, and the oil tank is in parallel with the side-by-side cargo hold troughs and connected and communicated with the two lateral oil cisterns, and the oil cistern combined with the two lateral oil cisterns is aerially viewed as a [symbol] -shape.

3. The oil cistern structure according to claim 2, wherein the lengths of three sides of the [symbol] -shape are equivalent or non-equivalent, or the lengths of at least two sides of the [symbol] -shape are equivalent.

4. The oil cistern structure according to claim 1, wherein the oil cistern comprises a division space between the cargo hold troughs and the two lateral oil cisterns.

5. The oil cistern structure according to claim 4, wherein bulkheads between the division space and the cargo hold troughs comprise a crushproof material or an elastic material.

6. The oil cistern structure according to claim 1, wherein the oil cistern comprises a capacity that is formed by reducing the cargo hold troughs adjoined to the two lateral oil cisterns, and the capacity is a division space of the oil cistern.

7. The oil cistern structure according to claim 6, wherein the division space comprises a crushproof structure or an elastic structure.

8. The oil cistern structure according to claim 1, wherein the water conveyance comprises a tanker, a dry cargo ship or a ship.

9. The oil cistern structure according to claim 1, wherein the oil cistern comprises being communicated with a double hull of bottom, and the double hull is used as an oil tank and disposed in a ballast tank under the cargo hold troughs.

10. The oil cistern structure according to claim 9, wherein an extractor is set between the oil tanks to transport the oil within.

11. The oil cistern structure according to claim 10, wherein the extractor is a pump, an oil hydraulic pump, a screw pump or a siphon device.

12. The oil cistern structure according to claim 9, wherein the oil tank comprises a compressible tank.

13. The oil cistern structure according to claim 12, wherein the compressible tank is compressed by the pressure of ballast water in the water conveyance.
